(19) United States
(12) Patent Application Publication
(10) Pub. No.: US 2007/0088987 A1
(43) Pub. Date: Apr. 19, 2007

(54) System and method for handling information transfer errors between devices

(76) Inventors: Hiroshi Kimizuka, Funabashi (JP); Jonathan Y. Zhang, Plano, TX (US); Steven David Sabin, Dallas, TX (US)

Correspondence Address: TEXAS INSTRUMENTS INCORPORATED, P O BOX 655474, M/S 3999, DALLAS, TX, 75265, US

(21) Appl. No.: 11/249,221

(22) Filed: Oct. 13, 2005

(51) Int. Cl. G06F 11/00

(52) U.S. Cl. 714/42

(57) ABSTRACT

Systems and methods are disclosed for handling errors occurring when a first device requests information from a second device. Optionally the information and any corresponding error information are sent from the second device to a buffer. After the first device optionally receives the information and the error information from the buffer, the first device determines whether an error is associated with the information, and in response to determining that an error is associated with the information, the first device processes the error.

### FIELD OF THE INVENTION

The invention relates generally to microprocessor error handling systems and methods. More particularly, the invention relates to systems and methods for handling errors during the transfer of information from a main memory to a processor through a cache.

### BACKGROUND OF THE INVENTION

Most computer systems include a processor that is coupled to a main memory from which the processor retrieves instructions and other data for processing. Typically, the processor can decode and execute instructions and process data at speeds that far exceed the speed at which instructions and operands can be fetched from the main memory to the processor. To overcome some of the problems associated with this speed mismatch, many computer systems include a cache memory between the processor and the main memory.

A cache is typically a small, high-speed memory buffer that temporarily holds a copy of those portions of the contents of the main memory that are likely to be needed in the near future by the processor. A cache shortens the time necessary to fetch data or instructions from the main memory to the processor. The processor first searches for a required instruction or other data in the cache before searching the main memory. The processor requests the instruction/data from the main memory only when the instruction/data is not present in the cache since information located in the cache can be accessed in much less time compared to information located in the main memory. Thus, a processor with a cache spends far less time waiting for instructions and operands to be fetched/stored from/to the main memory. To further increase performance, processors can speculatively prefetch information from the main memory and store the information in the cache in anticipation of requiring the information at a later time.

At times, accessing the main memory to populate the cache can generate errors. An error can occur, for example, because the memory location being accessed is not available, there is a physical problem with accessing the main memory, an illegal memory location is being accessed, and so on. When such an error occurs, the system generates an interrupt to handle the error, often interrupting the processing flow and flushing and resetting the processor. It typically then takes several clock cycles to reset the processor and to return to the regular processing of information. Due to the speculative nature of fetching information from the main memory to the cache, often the information fetched to the cache is discarded before the information is used by the processor. Thus, it is often the case that the processor handles an error (by generating an interrupt, and so on) from information in the cache that the processor may never use.

### SUMMARY OF THE INVENTION

One or more of the problems outlined above may be solved by the various embodiments of the invention. Broadly speaking, the invention includes systems and methods for handling errors occurring when a first device requests information from a second device. Optionally the information and any corresponding error information are sent from the second device to a buffer. After the first device optionally receives the information and the error information from the buffer, the first device determines whether an error is associated with the information, and in response to determining that an error is associated with the information, the first device processes the error.

In one embodiment of the present invention, the first device is adapted to request information from the second device. The first device may be a processor and the second device may be a main memory, for example. In one embodiment, the first device may be adapted to request speculatively data from the second device.

The second device is adapted to send the information to a buffer coupled to the second device and to the first device. In addition, the second device is adapted to send to the buffer error information corresponding to the information. An error can occur, for example, if a request is made to an illegal memory location, to a bad memory location, or to a missing physical or virtual location. The buffer is adapted then to store the information and the corresponding error information.

The first device is adapted to receive the information and the corresponding error information. In one embodiment, the first device is adapted to determine whether an error is associated with the information and to process the error only after the first device receives the error information from the buffer. If the first device determines that an error is associated with the information, the first device is adapted to process the error, by generating an interrupt, for example. In addition, the first device may send the error information and the interrupt to other devices in the system. Furthermore, the first device is adapted to substitute the information with “null” information in response to determining that the error is associated with the information.

In one respect, disclosed is a method for handling error information, including: requesting information from a device; receiving from the device and storing into a buffer the information and error information corresponding to the information; receiving the information and the error information corresponding to the information from the buffer; determining, using the error information, whether an error is associated with the information; and processing the error in response to determining that the error is associated with the information.

In another respect, disclosed is an information handling system including: a first device; a buffer coupled to the first device; and a second device coupled to the buffer. The first device is adapted to request information from the second device, and in response thereto, the buffer is adapted to store the information and error information corresponding to the information, the first device is adapted to receive the information and the error information corresponding to the information from the buffer, the first device is adapted to determine whether an error is associated with the information using the error information, and the first device is adapted to process the error in response to determining that the error is associated with the information.

In yet another respect, disclosed is a computer program product including a computer operable medium containing one or more instructions that are effective to cause a computer to perform the method that includes: requesting information from a device; receiving from the device and storing into a buffer the information and error information corresponding to the information; receiving the information and the error information corresponding to the information from the buffer; determining, using the error information, whether an error is associated with the information; and processing the error in response to determining that the error is associated with the information.

Numerous additional embodiments are also possible.

### BRIEF DESCRIPTION OF THE DRAWINGS

Other objects and advantages of the invention may become apparent upon reading the following detailed description and upon reference to the accompanying drawings.

FIG. 1 is a block diagram illustrating a system for handling errors during the transfer of information from a second device to a first device in accordance with some embodiments.

FIG. 2 is a block diagram illustrating the storing of error information during the transfer of information from a main memory to a cache in accordance with some embodiments.

FIG. 3 is a block diagram illustrating the handling of error information by a processor receiving instructions from a cache in accordance with some embodiments.

FIG. 4 is a timing diagram illustrating the state of signals during the handling of error information by a processor in accordance with some embodiments.

FIG. 5 is a flowchart illustrating a method for storing error information during the transfer of instructions from a main memory to a cache in accordance with some embodiments.

FIG. 6 is a flowchart illustrating a method for detecting error information by a processor while receiving instructions from a cache in accordance with some embodiments.

FIG. 7 is a flowchart illustrating a method for handling an error detected by a processor while receiving instructions from a cache in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as defined by the appended claims.

### Notation and Nomenclature

Certain terms are used throughout the following description and claims to refer to particular system components and configurations. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . .” Also, the term “couple” or “couples” is intended to mean either an indirect or direct electrical connection. Thus, if a first device couples to a second device, that connection may be through a direct electrical connection or though an indirect electrical connection via other devices and connections. Furthermore, the term “information” is intended to refer to any data, instructions, or control sequences that may be communicated between components of the device. For example, if information is sent between two components, data, instructions, control sequences, or any combination thereof may be sent between the two components.

### DETAILED DESCRIPTION OF THE EMBODIMENTS

One or more embodiments of the invention are described below. It should be noted that these embodiments are exemplary and are intended to be illustrative of the invention rather than limiting.

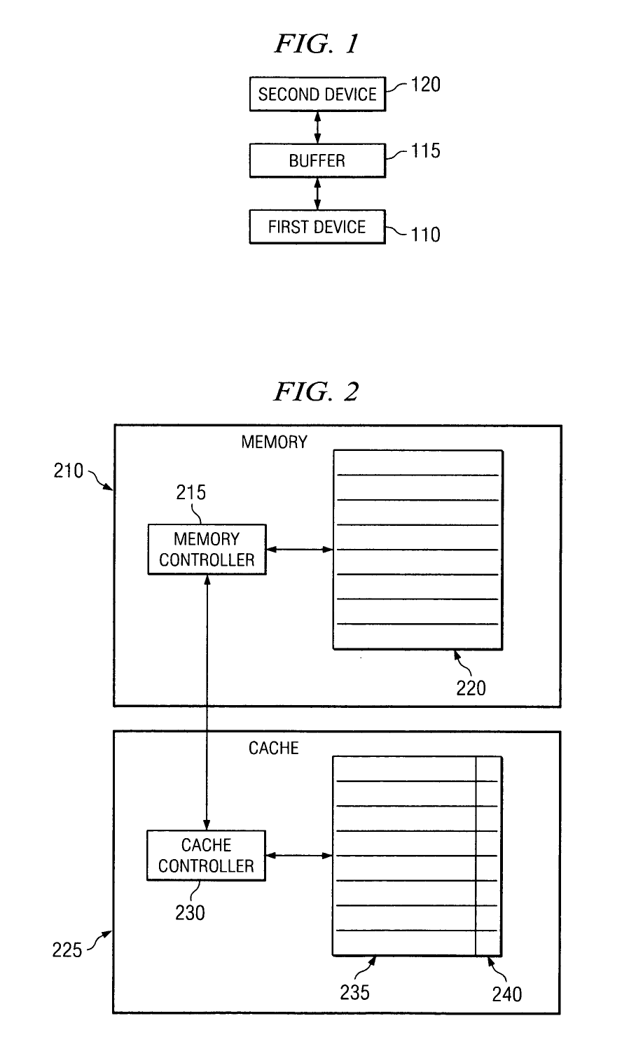

Referring to FIG. 1, a block diagram illustrating a system for handling errors during the transfer of information from a second device to a first device in accordance with one embodiment is shown. First device 110 is adapted to request second device 120 to send information to buffer 115. In one embodiment, first device 110 is adapted to request the information speculatively. First device 110 may request the information to be transferred to buffer 115 speculatively and then request the information from buffer 115, for example, in order to increase information transfer efficiency in cases where the speed with which device 110 can access buffer 115 is much higher than the speed with which device 110 can access device 120.

Buffer 115 is adapted to store temporarily the information received from device 120. The information may then either be transferred to first device 110 or discarded if the information is not requested by first device 110 at a later time. In one embodiment, device 110 may be a processor configured to receive information from a main memory (device 120) through a cache (buffer 115).

In one embodiment, when device 110 requests for information to be transferred from device 120 to buffer 115, information about the error is also sent to buffer 115. Buffer 115 is adapted to receive the error information and to store the error information in association with the corresponding information. When and if device 110 requests the information from buffer 115, buffer 115 is adapted to send the information, and in addition, buffer 115 is adapted to send to device 110 the error information.

After receiving the information and the error information, device 110 is adapted to examine the error information in order to determine whether an error is associated with the information. If device 110 determines that an error is associated with the information, device 110 is adapted to generate an interrupt, replace the information associated with the error with null information, and/or send the error information and the interrupt to other devices in the system.

In one embodiment, the error is not processed until the information corresponding to the error is fetched to device 110. Thus, the error is not processed and an interrupt is not generated in the cases where an error occurs but the corresponding information is speculatively transferred to buffer 115 and is never requested by device 110.

In another embodiment, two or more levels of caches may be present, such as a level 1 cache and a level 2 cache. In one embodiment, the level 1 cache may be implemented on the same chip as the processor. In yet another embodiment, only a subset of the caches may be configured to store error information, such as the level 1 cache. Storing error information only in a smaller cache can reduce the amount of space required to allocate to storing the error information.

In one embodiment, only the error information may be stored without the “bad” data. The error information may be stored in one of the caches or in another memory location adapted to store the error information.

Referring to FIG. 2, a block diagram illustrating the storing of error information during the transfer of information from a main memory to a cache in accordance with one embodiment is shown. Memory 210 is configured to receive instruction requests from a processor coupled to cache 225 and to send the requested instruction to cache 225. Memory controller 215 is configured to receive the instruction request, to fetch the requested instruction from memory cells 220, and to send the requested instruction to the cache 225.

In one embodiment, memory controller 215 is also configured to determine whether an error occurs during the fetching of the requested instruction. An error can occur, for example, if an illegal memory location is requested, if the memory location being requested is bad, or if the physical or virtual memory location being requested does not exist. Memory controller 215 is configured to send error instruction corresponding to the instruction to cache 225.

Cache controller 230 is configured to receive the instruction sent by memory controller 215 and to store the instruction in memory locations 235. Memory controller 225 is also configured to receive error data received by memory controller 215 corresponding to the instruction. Memory controller 225 is configured to store the error data in memory locations 240 in a location corresponding to the appropriate instruction entry. Cache controller 230 is configured to send when requested to do so the instruction entries and the corresponding error data entries to the attached processor.

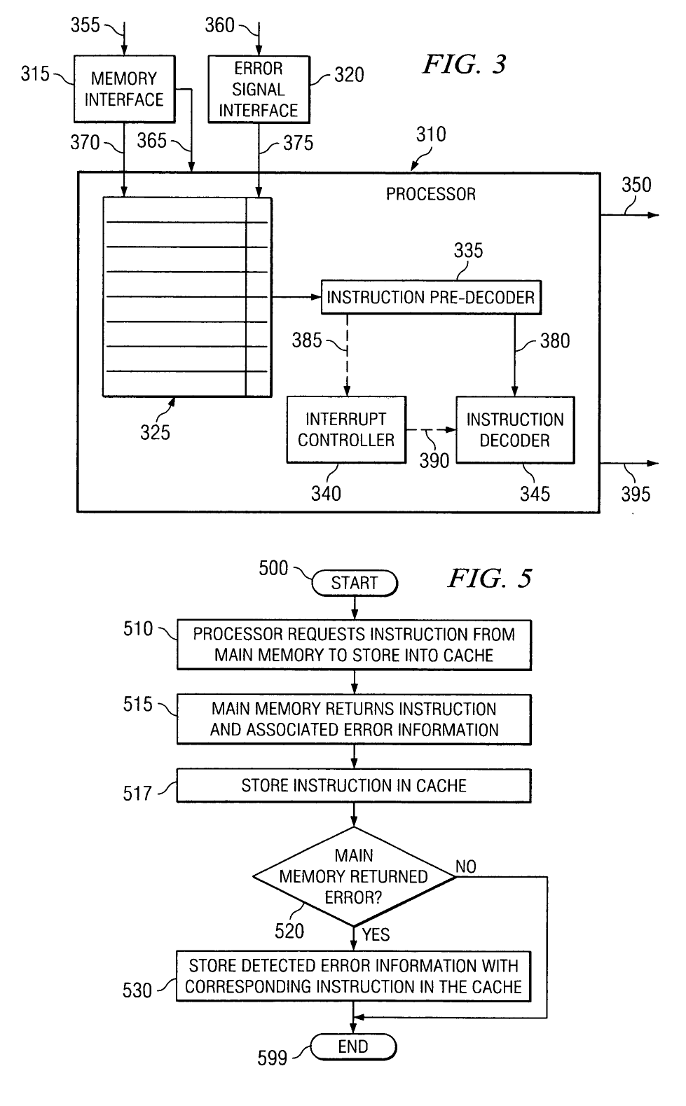

Referring to FIG. 3, a block diagram illustrating the handling of error information by a processor receiving instruction from a cache in accordance with one embodiment is shown. In one embodiment, processor 310 is configured to request instructions for processing from a cache attached to the processor using request signal 350. In one embodiment, a portion of these instructions was speculatively requested from a main memory and then sent to the cache.

In response to request signal 350, the cache sends the requested instruction to the processor using signal 355. In addition to sending the requested information, the cache sends to the processor any error information associated with the requested instruction using signal 360. In one embodiment, the requested information is initially received by memory interface 315, which then sends the instruction to the processor using signal 370. The received instruction is initially stored by the processor in pre-fetch buffer 325. Any corresponding error information to the instruction is initially sent to error signal interface 320, which then sends the error information to the processor using signal 375. The received error information is also initially stored in prefetch buffer 325 in a location associated with the instruction corresponding to the instruction with which the error information is associated.

Instruction pre-decoder 335 is configured to receive instructions and any corresponding error information from pre-fetch buffer 325. In one embodiment, instruction pre-decoder 335 is further configured to decode the received error information in order to determine whether an error is associated with the received instruction.

If instruction pre-decoder 335 determines that no error is associated with the received instruction, instruction pre-decoder 335 sends the instruction to instruction decoder 346 for further processing using signal 380. On the other hand, if an error is detected, instruction pre-decoder 335 is configured to send an interrupt signal to interrupt controller 340 using signal 385. In addition, instruction pre-decoder 335 is configured to substitute a “null” or a “no-op” instruction for the instruction corresponding to the detected error. The “null” or “no-op” instruction is then sent to instruction decoder 345 in place of the instruction containing the error. In one embodiment, sending a “null” or a “no-op” instruction in place of the actual instruction prevents instruction decoder 345 and generally the processor from going into a dangerous and unknown state.

In one embodiment, interrupt controller 340 is configured to receive the interrupt request from instruction pre-decoder 335 and, in response thereto, generate an interrupt in order for the processor and for other devices in the system to handle the detected error. In addition, the detected error information may be sent to other devices outside the processor using signal 395 in order to inform the other devices of the detected error.

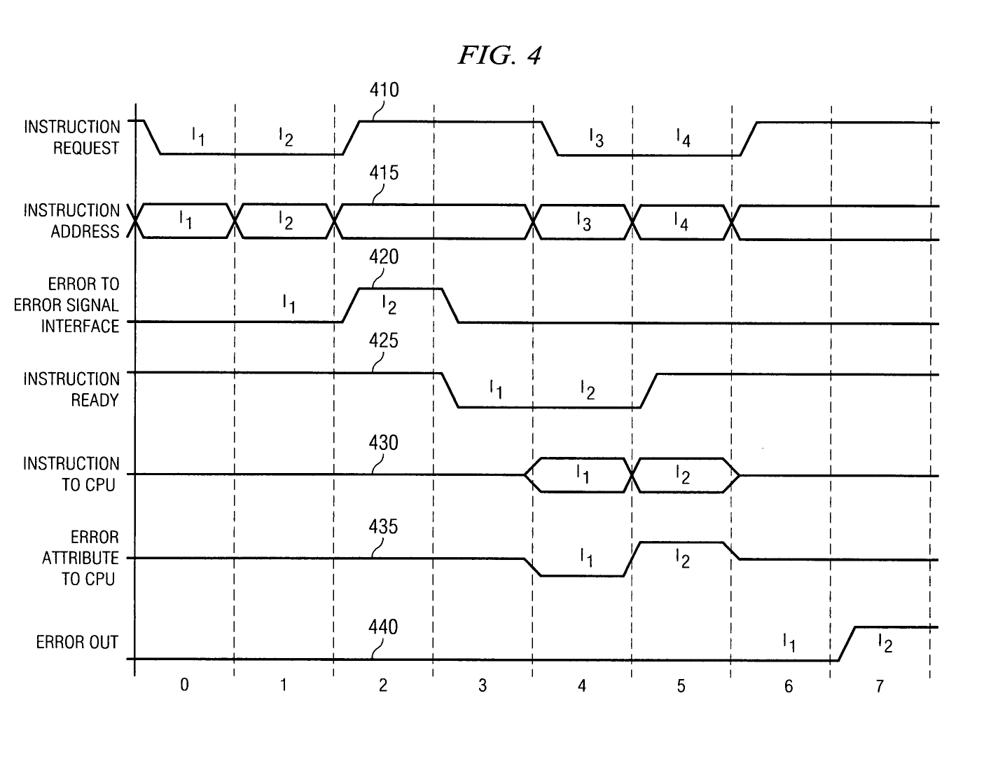

Referring to FIG. 4, a timing diagram illustrating the state of signals during the handling of error information by a processor in accordance with one embodiment is shown. The timing diagram shows the state of several signals associated with the processor from clock cycle 0 to clock cycle 7.

Signal 410 is used by the processor to indicate to a cache attached to the processor that the processor wants to receive an instruction from the cache. Signal 410 is configured to be low when an instruction is being requested from the cache by the processor during a given clock cycle. In the example shown, four instructions are requested: instruction 1 is requested at clock cycle 0; instruction 2 is requested at clock cycle 1; instruction 3 is requested at clock cycle 4; and instruction 4 is requested at clock cycle 5.

Signal 415 is used by the processor to indicate to the cache the address of the instruction being requested. In the example shown, instruction 1 address is sent at clock cycle 0, instruction 2 address is sent at clock cycle 1, instruction 3 address is sent at clock cycle 4, and instruction 4 address is sent at clock cycle 5. The address is used by the cache to determine which instruction to send to the processor at a given clock cycle.

Signal 420 represents the error signal received at the error signal interface of the processor. The error signal is configured to remain low to indicate that no error has occurred and is configured to go high in order to indicate that an error is associated with a given instruction. In the example shown, an error corresponding to the instruction 2 is indicated at clock cycle 2.

Signal 425 is used by the cache to indicate to the processor that an instruction previously requested by the processor is ready to be sent to the processor. The instruction ready signal is configured to be high except when an instruction is ready to be sent. In the example shown, the instruction ready signal is low in clock cycle 3 to indicate that instruction 1 is ready to be sent. The instruction ready signal is also low in clock cycle 4 to indicate that instruction 2 is ready to be sent.

Signal 430 represents the instruction being sent to the processor by the cache. In the example shown, instruction 1 is sent at clock cycle 4 and instruction 2 is sent at clock cycle 5. Signal 435 represents the error information being sent to the processor by the error signal interface. The error signal is configured to go low to indicate that no error is associated with the instruction. The error signal is configured to go high to indicate that an error is associated with the instruction. In the example shown, the error signal indicates that no error is associated with instruction 1 (clock cycle 4) and that an error is associated with instruction 2 (clock cycle 5).

Signal 440 represents the error that may be sent out by the processor to other devices in the system in order to indicate to those devices that an error has occurred. The error signal is normally low and goes high to indicate to other devices in the system that an error has occurred. In the example shown, at clock cycle 6, the error signal remains low to indicate that there is no error associated with instruction 1. At clock cycle 7, the error signal goes high to indicate that there is an error associated with instruction 2.

Referring to FIG. 5, a flowchart illustrating a method for storing error information during the transfer of instructions from a main memory to a cache in accordance with one embodiment is shown. Processing begins at 500 whereupon, at block 510, the processor requests an instruction from the main memory. In one embodiment, the processor may speculatively request the instruction. The instruction is stored in the cache in anticipation to the processor's requesting the instruction from the cache at a later time.

At block 515, the main memory sends the requested instruction to the cache. In addition, if an error occurs during the transaction, an error code is stored in the cache in association with the requested instruction. An error may occur during the instruction request for example, because an illegal memory location was requested, the physical location was bad, or the physical or virtual location is missing. At block 517, the instruction is stored in the cache.

A determination is then made as to whether the main memory returned an error during the transaction at decision 520. If an error was returned by the main memory, decision 520 branches to the “yes” branch whereupon, at block 530, the error information is stored in the cache in association with the corresponding instruction. In one embodiment, no further action is taken in response to the detected error information. Processing subsequently ends at 599. On the other hand, if the main memory does not return an error, decision 520 branches to the “no” branch and block 530 is bypassed.

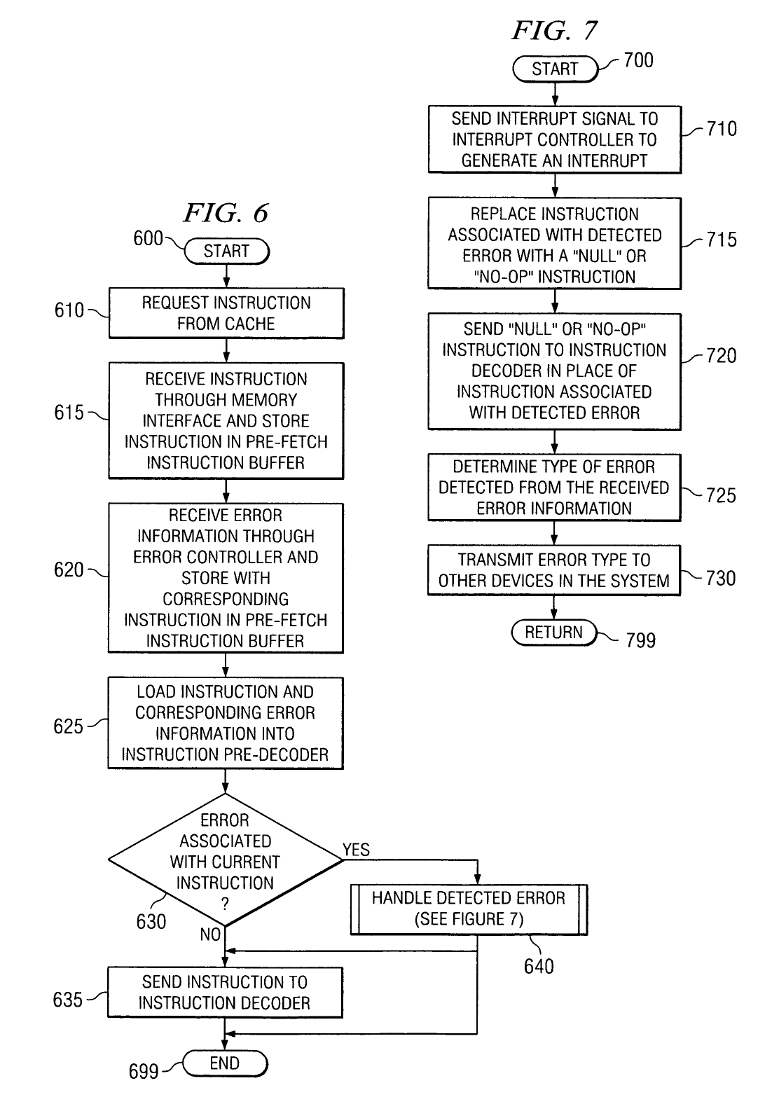

Referring to FIG. 6, a flowchart illustrating a method for detecting error information by a processor while receiving instructions from a cache in accordance with one embodiment is shown. Processing begins at 600 whereupon, at block 610, the processor requests an instruction from the cache, and at block 615, the processor receives the instruction from the cache through the processor's memory interface and stores the instruction in the pre-fetch instruction buffer.

At block 620, the processor receives error information corresponding to the received instruction through the processor's error controller. In one embodiment, the error information is stored in association with the corresponding received instruction.

At block 617, the instruction and the associated error information are loaded into the instruction pre-decoder. A determination is then made as to whether the error information corresponding to the current instruction indicates that there is an error associated with the instruction at decision 630. If no error is associated with the current instruction, decision 630 branches to the “no” branch whereupon, at block 635, the instruction is sent to the instruction decoder for further processing. Processing subsequently ends at 699.

On the other hand, if an error is associated with the current instruction, decision 630 branches to the “yes” branch whereupon, at predefined process 640, the detected error is handled. Predefined process 640 is described in more detail in FIG. 7 and corresponding text. Processing subsequently ends at 699.

Referring to FIG. 7, a flowchart illustrating a method for handling an error detected by a processor while receiving instructions from a cache in accordance with one embodiment is shown. Processing begins at 700 whereupon, at block 710, in response to the detected error, an interrupt signal is generated and sent to the interrupt controller. The interrupt controller then configured to generate an interrupt in response to receiving the interrupt signal.

At block 715, the instruction corresponding to the detected error is replaced with a “null” or a “no-op” instruction. The instruction associated with the detected error is replaced in order to avoid placing the processor in unknown and potentially harmful state due to a potentially bad instruction. At block 720, the “null” or “no-op” instruction is sent to the instruction decoder in place of the instruction containing the error.

At block 725, the type of error and the cause of the error that occurred are determined using the error information received. In one embodiment, different types of interrupts may be generated, for example, depending on the type of errors and the causes of the errors. At block 730, the processor may transmit the error information to other devices in the system that may need to respond to the detected error. Processing returns at 799.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with general purpose processors, digital signal processors (DSPs), application specific integrated circuits (ASICs), field programmable gate arrays (FPGAs) or other programmable logic devices, discrete gates or transistor logic, discrete hardware components, or any combination thereof designed to perform the functions described herein. A general purpose processor may be any conventional processor, controller, microcontroller, state machine or the like. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms ‘comprises,’ ‘comprising,’ or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions, and improvements to the embodiments described above are possible. It is contemplated that these variations, modifications, additions and improvements fall within the scope of the invention as detailed within the following claims.

What is claimed is:

1. A method for handling error information, the method comprising:
initially requesting information from a device;
storing into a buffer error information corresponding to the requesting the information; and
receiving the error information from the buffer in response to subsequently requesting the information.

2. The method of claim 1, wherein the initially requesting the information comprises speculatively requesting information from the device to store into the buffer.

3. The method of claim 1, further comprising receiving and storing into the buffer the information.

4. The method of claim 1, further comprising:
determining, using the error information, whether an error is associated with the requesting the information; and
processing the error in response to determining that the error is associated with the information.

5. The method of claim 4, further comprising determining whether the error is associated with the information only after receiving the error information from the buffer.

6. The method of claim 4, wherein the processing the error comprises generating an interrupt.

7. The method of claim 6, further comprising sending the interrupt and the error information to other devices.

8. The method of claim 4, wherein the processing the error comprises substituting the information with “null” information.

9. The method of claim 1, wherein the second device is a main memory.

10. The method of claim 1, wherein the error information is chosen from a group consisting of: illegal memory location, bad memory location, and missing physical or virtual memory location.

11. An information handling system comprising:
a first device;
a buffer coupled to the first device; and
a second device coupled to the buffer, wherein:
the first device is adapted to initially request information from the second device,
the buffer is adapted to store error information corresponding to the information in response to the first device initially requesting the information from the second device, and
the first device is adapted to receive the error information from the buffer in response to subsequently requesting the information.

12. The system of claim 11, wherein the first device being adapted to initially request the information comprises the first device being adapted to speculatively request the information.

13. The system of claim 11, further comprising receiving and storing the information into the buffer.

14. The system of claim 11, wherein:
the first device is adapted to determine whether an error is associated with the information using the error information, and
the first device is adapted to process the error in response to determining that the error is associated with the information.

15. The system of claim 14, wherein the first device is adapted to determine whether the error is associated with the information and to process the error only after the first device receives the error information from the buffer.

16. The system of claim 14, wherein the first device is further adapted to generate an interrupt in response to determining that the error being associated with the information.

17. The system of claim 16, wherein the first device is adapted to send the interrupt and the error information to other devices.

18. The system of claim 14, wherein the first device is further adapted to substitute the information with “null” information in response to determining that the error is associated with the information.

19. The system of claim 11, wherein the first device is a processor and the second device is a main memory.

20. The system of claim 11, wherein the error information is chosen from a group consisting of: illegal memory location, bad memory location, missing physical or virtual memory location.

21. A computer program product comprising a computer operable medium containing one or more instructions that are effective to cause a computer to perform the method comprising:
initially requesting information from a device;
storing into a buffer error information corresponding to the requesting the information; and
receiving the error information from the buffer in response to subsequently requesting the information.

22. The product of claim 21, wherein the requesting information from the device comprises speculatively requesting information from the device.
